(19) United States
(12) Patent Application Publication
(10) Pub. No.: US 2025/0141305 A1
(43) Pub. Date: May 1, 2025

(54) FITTING

(71) Applicant: CAMOZZI AUTOMATION S.P.A., Milano (IT)

(72) Inventors: Peter BELLINI, Milano (IT); Mauro BIGNOTTI, Milano (IT); Andrea CAMISANI, Milano (IT); Paolo CORTESI, Milano (IT); Claudio FINULLI, Milano (IT); Gian Pietro GHIROLDI, Milano (IT); Alberto MINGOTTI, Milano (IT); Marco ROSSI, Milano (IT); Francesca TEDESCHI, Milano (IT); Fabio VITALI, Milano (IT); Alessandro ZANACCHI, Milano (IT); Gloria BIANCO, Pisa (IT); Francesco INGLESE, Pisa (IT); Godfried JANSEN VAN VUUREN, Pisa (IT); Antonio PATERLINI, Pisa (IT); Donato ROMANO, Pisa (IT); Gaspare SANTAERA, Pisa (IT); Cesare STEFANINI, Pisa (IT)

(21) Appl. No.: 18/928,356

(22) Filed: Oct. 28, 2024

(30) Foreign Application Priority Data
Oct. 31, 2023 (IT) 102023000022836
Oct. 17, 2024 (IT) 102024000023115

(51) Int. Cl. H02K 7/18; G01D 11/00

(52) U.S. Cl. CPC H02K 7/1823; G01D 11/00

(57) ABSTRACT

A fitting for a pressurized fluid circuit having an impeller drivable in rotation by a pressurized fluid crossing the fitting is provided. The impeller supports a plurality of magnets coupled to a plurality of coils for generating an electric current in the presence of a variable magnetic field generated by a rotation of the magnets.

### CROSS-REFERENCE TO RELATED APPLICATIONS

This application claims priority to Italian Patent Application No. 102023000022836 filed Oct. 31, 2023, and to Italian Patent Application No. 102024000023115 filed Oct. 17, 2024, the entire contents of which is hereby incorporated in its entirety by reference.

### FIELD OF THE INVENTION

The present invention relates to a fitting for fluids, for example compressed air, comprising impeller means drivable by the pressurized fluid crossing the fitting to generate electrical energy.

### BACKGROUND OF THE INVENTION

Pneumatic or hydraulic devices, in particular valves for regulating the flow of a fluid, are known to be provided with means for recovering kinetic and/or potential energy that would otherwise be wasted. The energy recovery means generally comprise a rotating element and diffusing means adapted to direct the fluid towards the recovery means.

A valve of this type is for example described in WO2014132187A2.

However, apart from the recovery of energy that would otherwise be lost, there is also an increasing need to utilize part of the kinetic and/or potential energy of a fluid flowing in a pneumatic and hydraulic component in order to produce electrical energy.

Hydraulic devices have already been proposed, for example in domestic thermal and sanitary installations, wherein water circulating within a component of the system, such as a pipe, a tap, a shower head, or the like, actuates a turbine that powers an electronic device to produce a light and/or sound effect for example.

There are industrial applications where it is necessary to detect or monitor by means of sensors certain quantities associated with the passage of a fluid, from the simple detection of the presence or absence of a fluid flow in a part of a circuit, to the detection of certain features of the fluid flow, for example the flow rate, pressure, temperature, humidity, etc., but where the electrical wiring of the sensors arranged in the part of the circuit of interest is very inconvenient or expensive, if not impossible.

In addition, also due to the environment wherein a component or part of a pressurized fluid circuit is installed, there may be very rigid constraints in terms of space and/or insulation (from water, humidity, external agents, heat, etc.) that the electrical energy generation means must meet.

### SUMMARY OF THE INVENTION

The object of the present invention is to provide a fitting for a pressurized fluid circuit capable of generating electrical energy, for example for powering sensors, whilst satisfying the aforementioned requirements for compactness, robustness, design simplicity, and insulation.

Said object is achieved by a fitting as described and claimed herein. Preferred or advantageous embodiments of the fitting are also described.

### BRIEF DESCRIPTION OF THE FIGURES

The features and advantages of the fitting according to the present invention shall be made apparent from the following description of preferred embodiments thereof, provided purely by way of non-limiting example, with reference to the accompanying figures, wherein:

FIG. 1 is a perspective view of the fitting according to the present invention;

FIG. 2 is a perspective view of the fitting in partial axial cross-section;

FIG. 3 is an axial cross-section of the fitting;

FIG. 4 is a cross-section of the fitting, at the impeller;

FIG. 5 is a perspective view, in partial axial cross-section, of a portion of the fitting;

FIG. 6 is an axial cross-section of a first element which forms the body of the fitting, in one embodiment;

FIG. 7 is an axial cross-section of a second element which forms the body of the fitting, in one embodiment;

FIG. 8 is a cross-section of the impeller according to the present invention;

FIG. 9 is a perspective view of the ring of coils of the fitting according to the present invention;

FIG. 10 is a perspective view of the electronic boards of the fitting according to the present invention;

FIG. 11 is an axial cross-section of a third element which forms the body of the fitting;

FIG. 12 is a perspective view of an example of a one-way valve used in the fitting according to the present invention; and

FIGS. 13A-C show some electrical circuits of the main electronic board of the fitting according to the present invention.

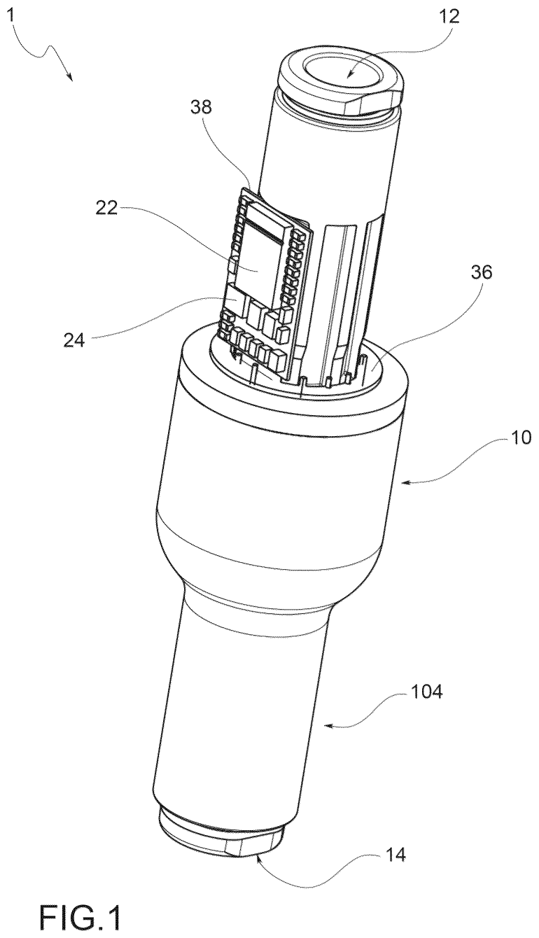

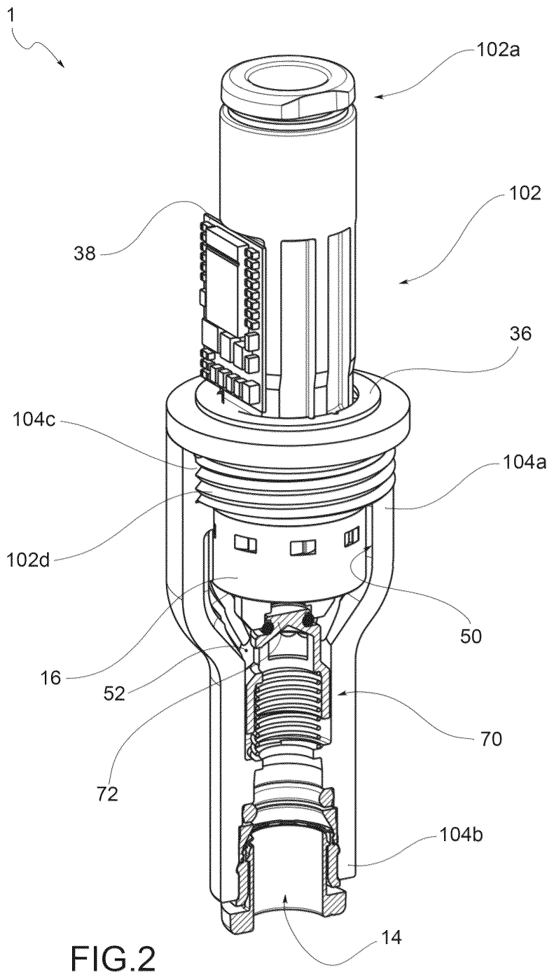

### DETAILED DESCRIPTION

In the drawings, reference numeral 1 indicates a fitting for a pressurized fluid circuit, for example a pneumatic circuit.

In the context of the present invention, the term “fitting” does not necessarily have to be understood in a strict sense to be a component which has the sole function of sealingly connecting two tubes or ducts of a pressurized fluid circuit (although the present invention, due to the features of compactness and robustness thereof, lends itself particularly to being applied to such a component), but may also comprise other components or parts of components wherein a pressurized fluid flows from a first passage (which may be defined as an inlet passage) to at least one second passage (which may be defined as an outlet passage), amongst which other functional elements may also be present, for example a shutter.

Furthermore, all directional references (e.g., upper, lower, upward, downward, left, right, towards the left, towards the right, at the top, at the bottom, above, below, vertical, horizontal, clockwise and counterclockwise) are used only for identification purposes in order to help the reader understand the described embodiments and do not create limitations, in particular with regard to the position, orientation or use of the described embodiments.

The conjunction references (e.g. fixed, coupled, connected, and the like) must be interpreted broadly and may include intermediate elements between a connection of elements and a relative movement between elements. The conjunction references do not therefore necessarily imply that two elements are directly connected in a fixed relationship with one another.

In a general embodiment, the fitting 1 comprises a fitting body 10 crossed by a main passage 11 for a pressurized fluid, such as compressed air.

The main passage 11 extends between a fluid inlet opening 12 and a fluid outlet opening 14.

In an embodiment illustrated in the drawings, the fitting body 10 extends mainly along a fitting axis Y, the fluid inlet opening 12, and the fluid outlet opening 14 being aligned with one another along said fitting axis Y. In other words, the fitting 1 is an inline fitting that extends in the same direction as the axis of an incoming tube and consequently also the axis of an outlet tube (not shown).

The present invention may however be implemented in other fitting layouts, such as “L” or “T” fittings.

In an embodiment shown in the drawings, the fluid inlet opening 12 and outlet 14 openings accommodate connection cartridges 60, for example of the super-fast type, for connecting to the respective tubes thereof.

An impeller 16 is housed in the fitting body 10, which impeller is rotatably drivable by the pressurized fluid crossing the fitting body 10.

In one embodiment, the impeller 16 is of the radial type, i.e., it is provided with a plurality of blades 16′, preferably curved blades, extending mainly in a radial direction from the center of the impeller, which coincides with the rotation axis X thereof, towards the outside.

In one embodiment, the impeller 16 has the rotation axis X coaxial to at least one portion of the main passage 11.

In other embodiments, the impeller 16 may have the rotation axis X orthogonal to the main passage 11.

The impeller 16 further supports a plurality of magnets 18, for example arranged within respective magnet seats 182 obtained within the body of the impeller 16 itself.

The magnets 18 are distributed circumferentially so as to form a magnet ring 180. For example, the magnet seats 182 are obtained coaxially to the rotation axis X of the impeller 16, and preferably are axially superimposed on the blades 16′ of the impeller 16, in such a way as to encompass the radial dimensions of the fitting.

A plurality of coils 20 is also housed within the fitting body 10. The coils 20 are distributed circumferentially so as to form a coil ring 200 magnetically coupled to the magnet ring 180. In the presence of a variable magnetic field, generated by the rotation of the magnet ring 180, an electric current is generated in the electrical windings of the coils 20 which has an intensity sufficient to be used to power electronic devices, as described hereinbelow.

For example, the coil ring 200 is coaxial to the rotation axis X of the impeller. Preferably, the coil ring 200 is axially superimposed on the magnet ring 180, so as to maximize the electric current generated by the variable magnetic field whilst at the same time encompassing the radial dimensions of the fitting.

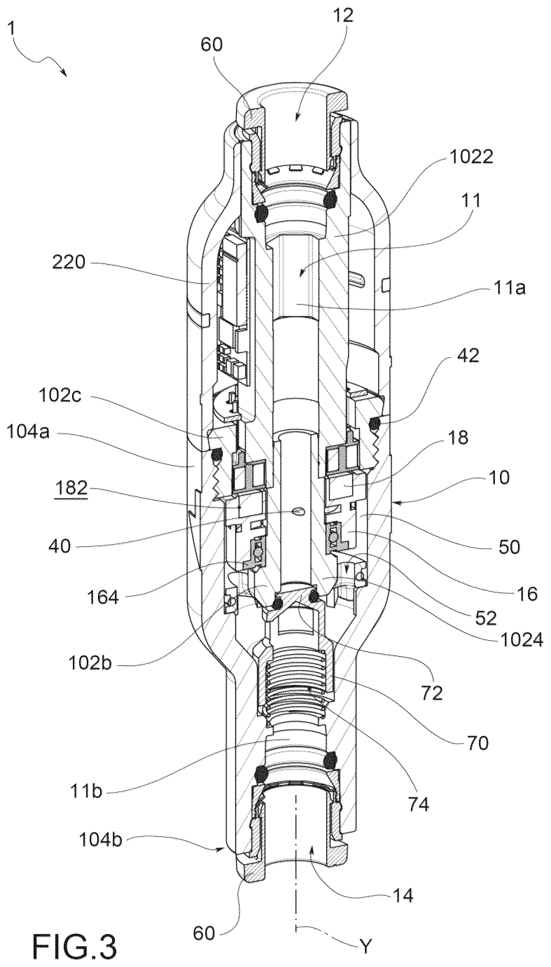

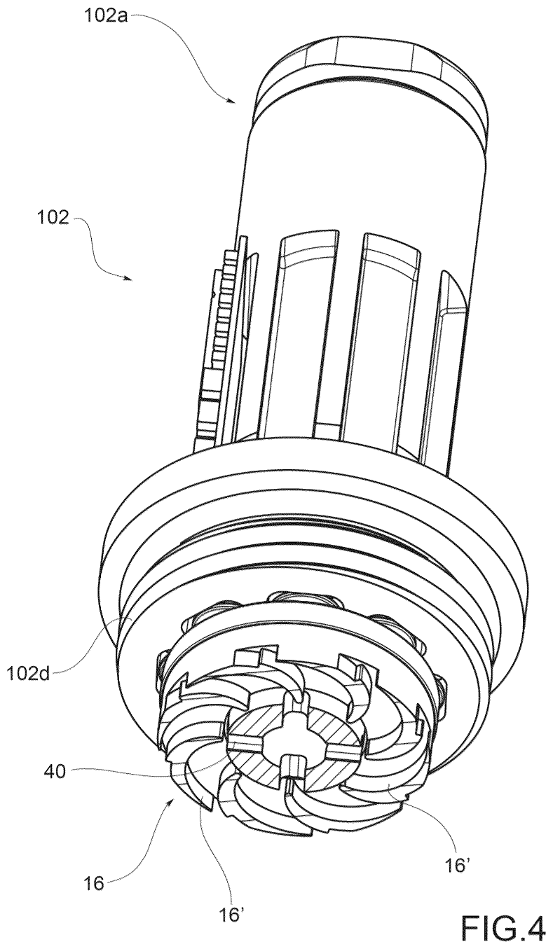

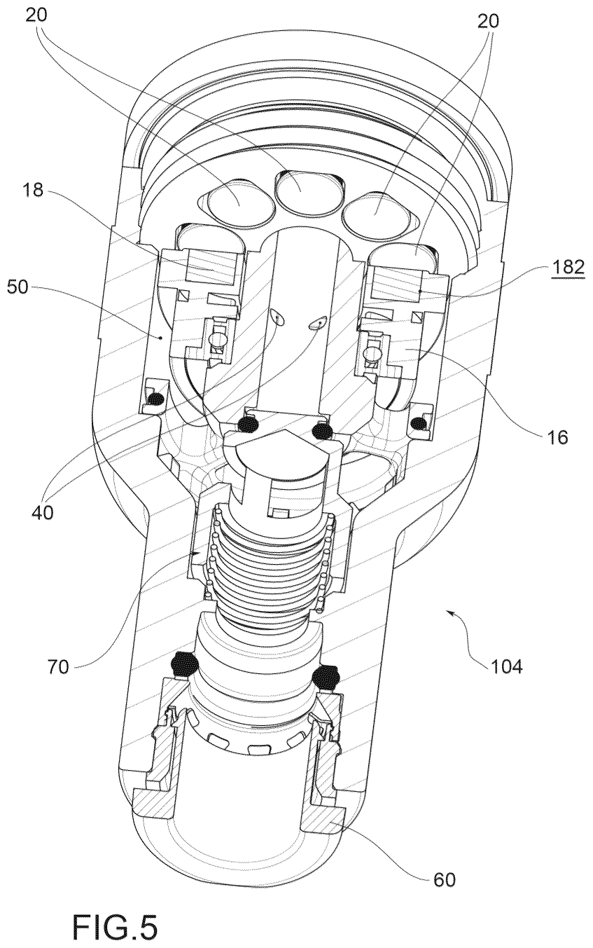

In a preferred embodiment, the electric current generated by the coils 20 powers at least one sensor 22 integrated into the fitting body 10, or otherwise encapsulated in a protective casing 220 fastened to the fitting body 10 (FIG. 3). For example, the at least one sensor 22 is suitable for detecting one or more of temperature, humidity, fluid pressure, flow rate.

In one embodiment, the electric current generated by the coils 20 also powers an electronic data transmission unit 24, such as a microprocessor unit.

In one embodiment, the electric current generated by the coils 20 also powers at least one LED, for example to indicate when the impeller produces energy.

The electronic data transmission unit 24 is operatively connected to the at least one sensor 22 and is configured to wirelessly transmit data received from the at least one sensor 22.

In one embodiment, the electronic data transmission unit 24 is configured to transmit, for example by means of a radio transmitter, a wireless presence signal when it receives voltage, i.e., it is powered by the current generated by the coils 20. For example, the presence signal is transmitted to a network or to a receiving device according to a predetermined communication protocol.

Also in the absence of sensors, the electronic data transmission unit 24 is configured to communicate at least the passage of fluid in the fitting, without further processing. This signal is sufficient to indicate that the impeller is rotating.

In one embodiment, the presence signal, for example sent to a network, includes a data packet containing a unique code for the fitting. This allows one or more devices receiving the presence signal, so as the other components of the network, to recognize the presence of said fitting.

The fitting may therefore be inserted into a network composed of several similar “smart” fittings 1.

For example, if, in a network that includes a plurality of fittings 1, wherein each fitting 1 sends, for example periodically, a flow present signal, the network detects that one of the fittings has stopped sending the signal, the network may automatically identify the anomalous fitting and assume that there is a problem (for example a detached tube or damaged gasket).

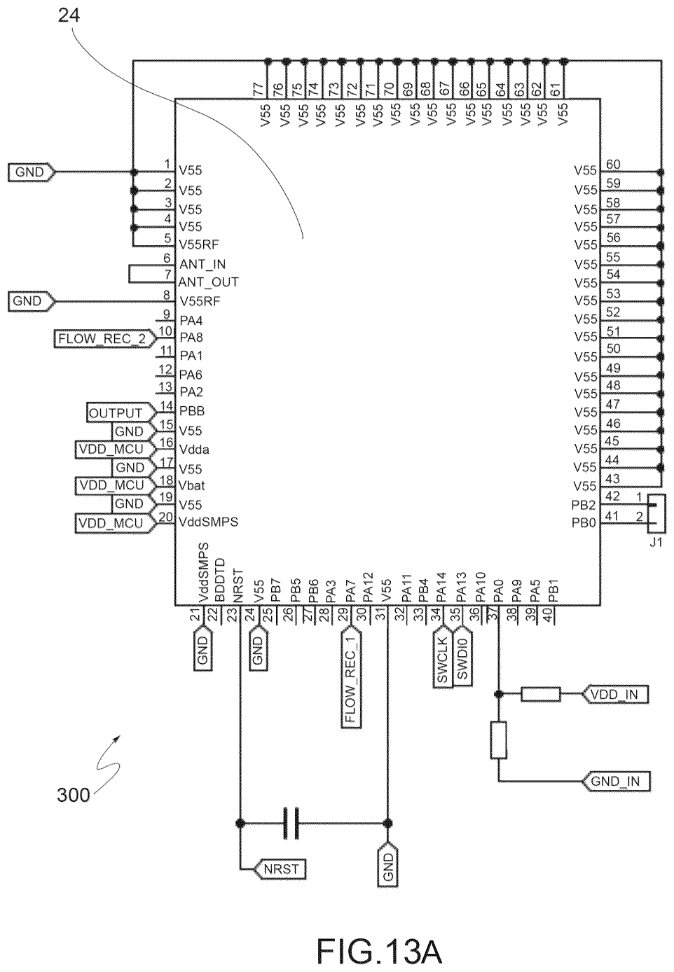

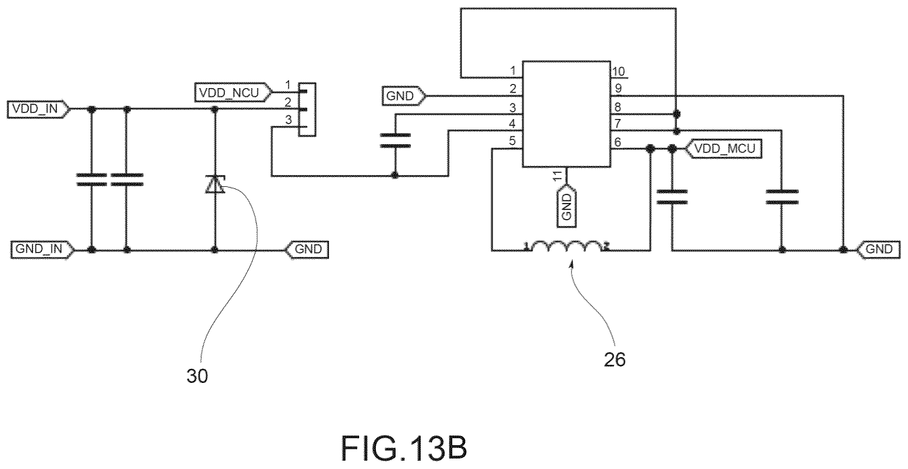

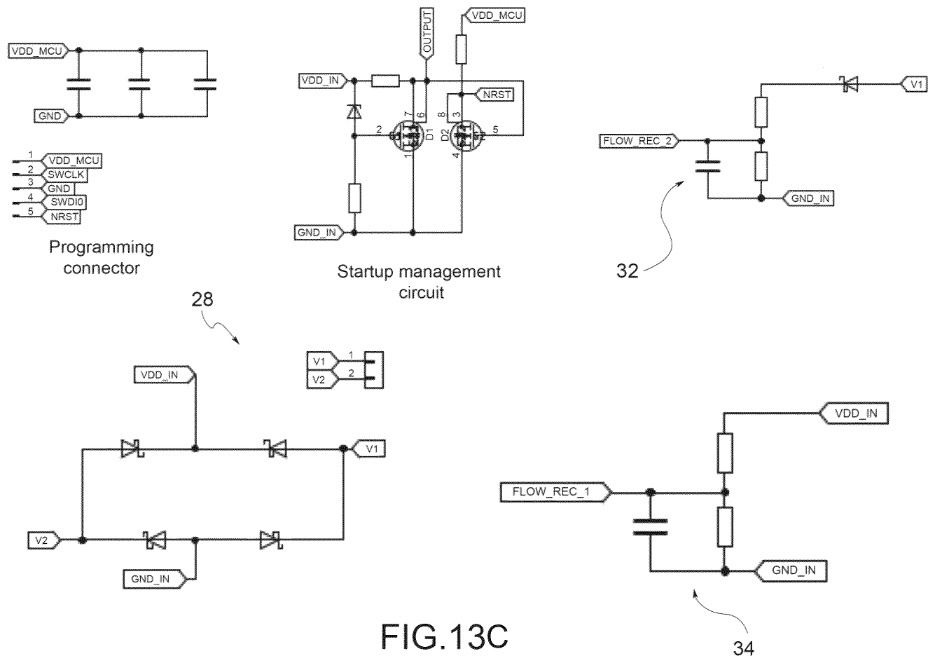

An example of an electronic circuit 300 adapted to manage the energy generated by the impeller 16 will now be described in more detail, with reference to FIGS. 13A-C. The electronic circuit 300 comprises, in addition to a micro-controller implementing the electronic data transmission unit 24 and that also implements the function of a radio transmitter, a power supply 26 that powers the components of the electronic circuit.

When the fluid flow is sufficient to allow the impeller 16 to produce electrical energy, the periodic wave thus generated is rectified by means of a rectifier bridge 28.

The rectified wave, suitably filtered and limited in amplitude, supplies a part of the circuit configured to generate the voltage necessary for the correct operation of the micro-controller.

In one embodiment, since in the presence of a flow with high flow rates the sinusoidal current wave generated by the coils 20 may reach peak-to-peak voltage levels that are harmful to the power supply, the power supply circuit 26 comprises a Zener diode 30 for protection.

Although this solution means that part of the energy produced by the impeller that is above the activation threshold of the Zener diode 30 is not used, a Zener diode is nevertheless chosen in such a way that the available energy is always sufficient to ensure the correct functioning of the components of the electronic circuit.

In one embodiment, the electronic circuit 300 is suitable for detecting fluid flow characteristics. For this purpose, the electronic circuit 300 comprises a rectified voltage reading circuit 32 and a half-wave voltage reading circuit 34 which, by means of a voltage splitter, allow the micro-controller to read the rectified and half-wave voltages.

By means of the rectified and the half-wave voltage it is possible to calculate the available instantaneous energy. With this information, it is possible to implement strategies for managing the low-power modes allowed for by the microprocessor, for example enabling or disabling the sensors 22.

By virtue of reading the half-wave voltage it is possible, for example, to estimate, by means of appropriate algorithms, the pressure and flow rate values.

In addition to one or more sensors 22 that may be connected to the electronic circuit 300, it is possible to connect actuators for manipulating the flow or for indicating the state of the device and the physical quantities monitored thereby.

All of the information collected by the sensors, calculated data and control signals for the actuators are transmitted via wireless technology (for example Bluetooth Low Energy), integrated into the microprocessor 24. This technology allows for communication with an external device and therefore one or more users to monitor, configure and control the connection.

Turning now to the construction features of the fitting, in one embodiment, the coils 20 are arranged in such a way as to have their respective axes parallel to the rotation axis X of the impeller.

Furthermore, the electrical terminals 202 of the coils 20 may also be oriented parallel to the rotation axis X of the impeller. This also allows the coils 20 to be connected in series with one another by means of an electronic coil connection board 36 with an annular shape, supported by the fitting body 10 coaxially to the rotation axis X of the impeller.

In other embodiments, for example wherein the magnets 18 are arranged on the outer circumference of the impeller 16, the coils 20 could also be arranged in this way, i.e., with the relative axes orthogonal to the rotation axis of the impeller.

The electronic coil connection board 36 is in turn connected to a main electronic board 38, whereupon the electronic circuit 300 described above is obtained and whereupon at least one sensor 22 may be mounted.

The main electronic board 38 may be arranged perpendicularly with respect to the electronic coil connection board 36, i.e., lying in a plane parallel to the rotation axis X of the impeller 16.

A plurality of nozzles 40 for supplying the impeller 16 is obtained in the fitting body 10. In one embodiment, said nozzles 40 extend radially from the main passage 11. For example, four nozzles 40 are obtained in the fitting body 10, spaced apart by an angle of 90° and perpendicular to the rotation axis X of the impeller 16.

The nozzles 40 emerge between the curved radial blades 16′ of the impeller 16.

In one embodiment, the impeller 16 integrates a ferromagnetic ring 162, i.e., a steel plate, suitable for amplifying the magnetic field.

In one embodiment, the impeller 16 is mounted, for the rotation and guidance thereof, upon at least one impeller support 164 coupled to the fitting body 10. For example, the impeller support 164 consists of a ball bearing or a sliding bush. In a variant embodiment, the impeller 16 is mounted with clearance on the fitting body 10 so that, when driven in rotation, an annular air cushion is formed between the impeller 16 and the fitting body 10. The air cushion allows the impeller to rotate suspended in the fitting body, without contact with the body and therefore without friction.

According to one aspect of the present invention, the impeller 16 is in fluid communication with the fluid outlet opening 14 of the fluid, in such a way that the portion of fluid flow that enters the supply nozzles 40 and supplies the impeller 16 is reconveyed towards the fluid outlet opening 14.

For example, the impeller 16 is in fluid communication with a distal segment of the main passage 11, which ends with the fluid outlet opening 14.

All of the pressurized fluid flow therefore crosses the fitting and exits from the fluid outlet opening 14, including the flow portion that feeds the impeller 16.

On the other hand, not all of the fluid entering the fitting passes through the impeller 16, i.e. not all of it is used to feed the impeller, only part of the flow.

The partialization of the flow entering the fitting for supplying the impeller has several advantages.

The energy taken from the fluid flow entering the fitting for feeding the impeller is a fraction of the total energy, so that most of the flow remains available for the final application (e.g., the actuation of a pneumatic cylinder).

In the event of breakage of the impeller or some of components thereof, the risk of fragments being transported into the circuit downstream of the fitting is limited.

Given the small area of the impeller blades, the fact of discharging a force onto the impeller generated by a fraction of the flow entering the fitting, and therefore a reduced force compared to that generated by the total flow, helps to increase the reliability of the fitting.

It should be noted that the ratio between the flow circulating in the impeller and the flow flowing in the main passage 11 depends upon the fact that the path of the impeller supply fluid has numerous pressure drops, in particular caused by the radial nozzles, which have a very small diameter and force the main flow to deviate abruptly, and by the impeller itself, which channels the flow by extracting mechanical work.

In one embodiment, the impeller 16 is housed within an impeller chamber 50 fluidly connected to the main passage 11 through a return passage 52.

The supply nozzles 40, the impeller chamber 50, and the return passage 52 in practice form a secondary, or bypass, passage connected in parallel to the main passage 11.

In one embodiment, the return passage 52 flows into the main passage 11 in proximity to the fluid outlet opening 14, or in any case into a distal portion of the main passage 11 between the supply nozzles 40 and the fluid outlet opening 14. In an embodiment shown in the drawings, the fitting body 10 comprises a first body section 102 and a second body section 104, arranged in succession along the direction of flow of the fluid crossing the fitting.

More specifically, a first section 11a of the main passage 11 is formed in the first body section 102. The first body section 102 extends between a first proximal portion 102a, which forms the fluid inlet opening 12, and a first distal portion 102b.

In one embodiment, the coil ring 200 is supported by this first body section 102.

In the second body section 104, a second section 11b of the main passage 11 is formed. The second body section 104 extends between a second proximal portion 104a and a second distal portion 104b, which forms the fluid outlet opening 14.

As may be seen in particular in FIG. 3, the first body section 102 of the fitting body 10 is partially and axially inserted into the second body section 104 of the fitting body 10. In particular, the second proximal portion 104a coaxially surrounds the first distal portion 102b so as to form, with the first distal portion 102b, the impeller chamber 50 wherein the impeller 16 is housed.

The impeller chamber 50 is in fluid communication with the second section 11b of the main passage 11. For example, the impeller chamber 50 is in the form of a cup, with a larger part accommodating the impeller and a part that progressively narrows and flows into the second section 11b of the main passage 11.

Therefore, the portion of the fluid flow entering the nozzles 40 and supplying the impeller 16 is redirected towards the fluid outlet opening 14 of the fitting.

In one embodiment, the first distal portion 102b of the first body section 102 of the fitting body 10 forms a peripheral flange 102c having a threaded outer surface 102d. The second proximal portion 104a of the second section 104 of the fitting body forms an internally threaded collar 104c suitable for screwing onto the peripheral flange 102c. A sealing ring 42 may be interposed between the two connecting elements.

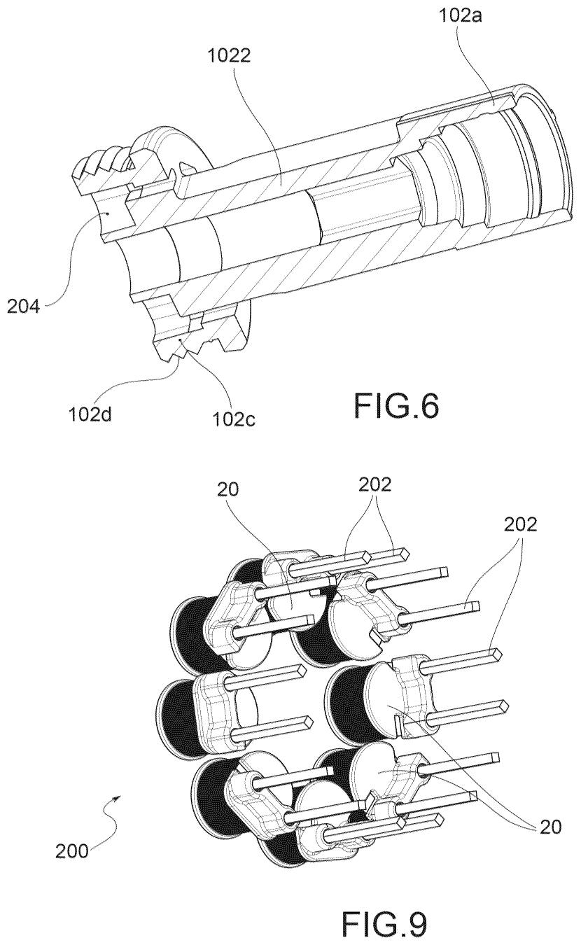

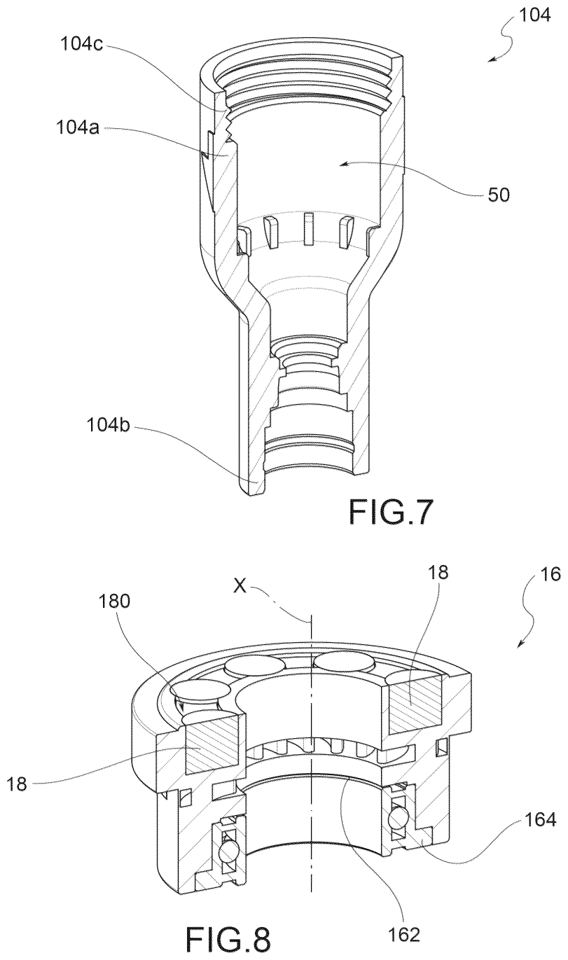

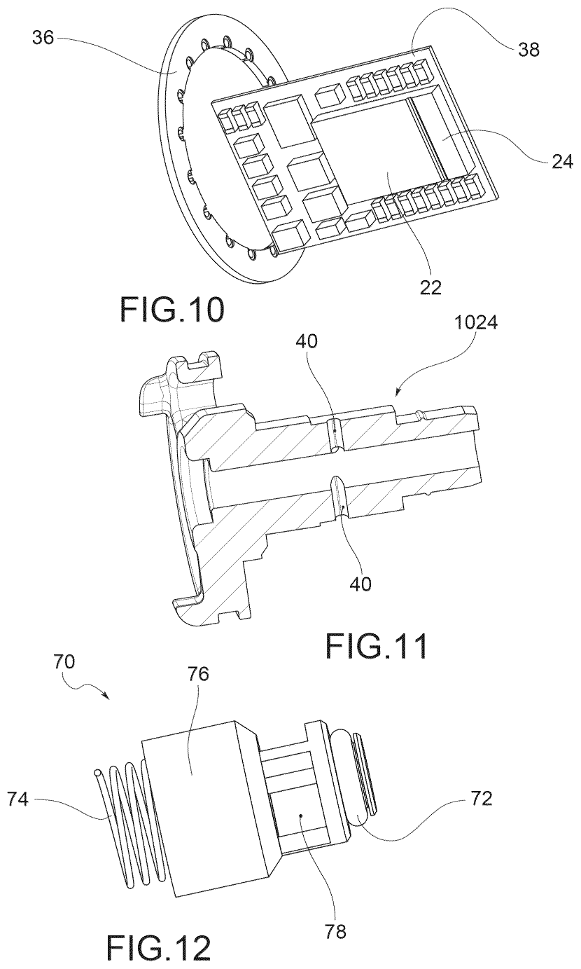

For example, the inner wall of the peripheral flange 102c radially delimits an annular coil seat 204 wherein the coil ring 200 is housed (FIG. 6).

In an embodiment shown in the drawings (FIGS. 3, 6 and 11), the first body section 102 of the fitting body 10 is in turn formed by the axial coupling between a first section first element 1022 (proximal to the direction of fluid flow within the fitting), and a first section second element 1024 (distal element).

In the first section second element 1024, the nozzles 40 for supplying the impeller 26 may be obtained.

In one embodiment, in the main passage 11, downstream of the impeller 16 with respect to the direction of the pressurized fluid, a one-way device 70 is housed that is configured to allow the passage of the fluid in the main passage 11 when the fluid acting on the one-way device 70 has reached a pressure that is sufficient to cause the generation of a predetermined amount of electrical energy.

The energy required to start the impeller from standstill is in fact greater than that necessary to keep it in rotation, once started.

In one embodiment, the one-way device 70 is calibrated so as to open when a minimum pressure difference threshold (ΔP) is reached between the fluid inlet opening and the fluid outlet opening of the fitting. Until such threshold is reached, all of the fluid entering the fluid inlet opening 12 impinges upon the impeller 26, thus facilitating the start-up thereof.

In one embodiment, the one-way device 70 consists of a one-way valve.

More specifically, in one embodiment the one-way valve 70 is housed in the second body section 104 and has an elastically pushed shutter element 72, for example by a helical spring 74, in a closed position of the distal end of the first section 11a of the main passage 11.

For example, the shutter element 72 is supported by a hollow valve body 76, provided with side openings 78, so as to allow the portion of the fluid flow that feeds the impeller 16 to flow towards the fluid outlet opening 14 even when the one-way valve 70 is in the closed position of the main passage 11.

In one possible variant embodiment, the one-way device 70 comprises a duckbill valve, which is a rubber element that only allows the passage of air, in one direction, when a certain pressure differential between the inlet and outlet is exceeded.

The one-way device 70 also makes it possible to limit the drop in pressure and to ensure an adequate flow rate at the outlet of the fitting.

A person skilled in the art may make several changes, adjustments, adaptations and replacements of elements with other functionally equivalent ones to the embodiments of the fitting according to the invention in order to meet incidental needs, without departing from the scope of protection as described and claimed herein. Each of the features described as belonging to a possible embodiment may be obtained independently of the other described embodiments.

What is claimed is:

1. A fitting for a pressurized fluid circuit, comprising:
a fitting body crossed by a main passage for a pressurized fluid, said main passage extending between a fluid inlet opening and a fluid outlet opening;
an impeller accommodated in the fitting body and drivable in rotation by the pressurized fluid crossing the fitting body;
a plurality of magnets supported by the impeller and distributed circumferentially so as to form a magnet ring;
a plurality of coils housed in the fitting body and distributed circumferentially so as to form a coil ring magnetically coupled to the magnet ring to generate an electric current in presence of a variable magnetic field generated by a rotation of the magnet ring,
wherein a plurality of nozzles for supplying the impeller is made in the fitting body, the plurality of nozzles extending radially from the main passage, and
wherein the impeller is in fluidic communication with the fluid outlet opening in such a way that a portion of a fluid flow that enters the nozzles and supplies the impeller is reconveyed towards the fluid outlet opening.

2. The fitting of claim 1, wherein the impeller is housed in an impeller chamber that is fluidically connected to the main passage through a return passage, the nozzles, the impeller chamber and the return passage forming a secondary passage that is connected in parallel to the main passage.

3. The fitting of claim 2, wherein the return passage flows into the main passage in proximity to the fluid outlet opening.

4. The fitting of claim 1, further comprising an electronic data transmission unit powered by an electric current generated by the plurality of coils.

5. The fitting of claim 4, further comprising at least one sensor powered by an electric current generated by the coil ring.

6. The fitting of claim 4, wherein the electronic data transmission unit is configured to wirelessly transmit a presence signal when powered by the electric current generated by the plurality of coils.

7. The fitting of claim 6, wherein said presence signal includes a data packet containing a fitting unique code.

8. The fitting of claim 5, wherein the electronic data transmission unit is operatively connected to the at least one sensor and is configured to wirelessly transmit data received from the at least one sensor.

9. The fitting of claim 1, wherein the coils are arranged so as to have respective axes parallel to a rotation axis of the impeller.

10. The fitting of claim 1, wherein the impeller has a rotation axis coaxial to at least one portion of the main passage.

11. The fitting of claim 1, wherein electrical terminals of the coils are oriented parallel to a rotation axis of the impeller.

12. The fitting of claim 1, wherein the fitting body comprises:
a first body section in which a first section of the main passage is formed, wherein the first body section extends between a first proximal portion forming the fluid inlet opening and a first distal portion, the coil ring being supported by said first body section;
a second body section in which a second section of the main passage is formed, wherein the second body section extends between a second proximal portion and a second distal portion which forms the fluid outlet opening,
wherein said second proximal portion coaxially surrounds the first distal portion so as to form, with the first distal portion, an impeller chamber in which the impeller is housed, and
wherein the impeller chamber is in fluid communication with the second section of the main passage.

13. The fitting of claim 1, wherein a one-way device is housed in the main passage, downstream of the impeller with respect to a direction of the pressurized fluid, configured to open the main passage when the pressurized fluid has reached a pressure sufficient to generate a pre-established amount of electricity.

14. The fitting of claim 12, wherein a one-way device is housed in the main passage, downstream of the impeller with respect to a direction of the pressurized fluid, configured to open the main passage when the pressurized fluid has reached a pressure sufficient to generate a pre-established amount of electricity, and wherein the one-way device is housed in the second body section and comprises a shutter element adapted to cooperate with a distal end of the first section of the main passage.

15. The fitting of claim 14, wherein the one-way device is a one-way valve, the shutter element being pushed by an elastic element to close the distal end of the first section of the main passage.

16. The fitting of claim 13, wherein the one-way device comprises a duckbill valve.

17. The fitting of claim 1, wherein the impeller is mounted, for rotation and guidance thereof, on at least one impeller support coupled to the fitting body, the at least one impeller support optionally being a ball bearing or a sliding bush.

18. The fitting of claim 1, wherein the impeller is mounted with clearance on the fitting body so that, when driven in rotation, an annular air cushion is formed between the impeller and the fitting body.

19. The fitting of claim 1, wherein the coils are electrically connected in series with one another.

20. The fitting of claim 1, wherein the fitting body extends along a fitting axis, the fluid inlet opening and the fluid outlet opening being mutually aligned along said fitting axis.

21. The fitting of claim 1, further comprising a main electronic board, on which at least one sensor, an electronic data transmission unit, and an electronic control unit are mounted, and an annular coil connection board to which electrical terminals of the coils are connected, wherein the annular coil connection board is connected to the main electronic board.
